(19) United States
(12) Patent Application Publication
(10) Pub. No.: US 2025/0349079 A1
(43) Pub. Date: Nov. 13, 2025

(54) CONTROLLABLE 3D SCENE EDITING VIA REPROJECTIVE DIFFUSION CONSTRAINTS

(71) Applicant: SAMSUNG ELECTRONICS CO., LTD., Suwon-si (KR)

(72) Inventors: Tristan Ty Aumentado-Armstrong, Toronto (CA); Marcus Anthony Brubaker, Toronto (CA); Konstantinos G. Derpanis, Toronto (CA); Aleksai Levinshtein, Thornhill (CA)

(73) Assignee: SAMSUNG ELECTRONICS CO., LTD., Suwon-si (KR)

(21) Appl. No.: 19/197,464

(22) Filed: May 2, 2025

Related U.S. Application Data
(60) Provisional application No. 63/645,596, filed on May 10, 2024.

(51) Int. Cl. G06T 19/00; G06T 15/20

(52) U.S. Cl. CPC G06T 19/00; G06T 15/205; G06T 2200/04

(57) ABSTRACT

A method of editing a three-dimensional (3D) image, may include: acquiring a 3D image based on a plurality of two-dimensional (2D) images; receiving an input for editing the 3D image; editing a first 2D image among the plurality of 2D images based on the input, to generate an edited first 2D image; generating a synthetic 2D image from a viewpoint of a second 2D image of the plurality of 2D images, by projecting pixels of the edited first 2D image to locations corresponding to the viewpoint of the second 2D image; editing the second 2D image based on the input and the synthetic 2D image, to generate an edited second 2D image; and generating an edited 3D image based on the edited first 2D image and the edited second 2D image.

### CROSS REFERENCE TO RELATED APPLICATION

This application claims priority from U.S. Provisional Patent Application No. 63/645,596, filed with the United States Patent and Trademark Office on May 10, 2024, the disclosure of which is incorporated herein by reference in its entirety.

### BACKGROUND

### 1. Field

The present disclosure concerns image editing. More specifically, the present disclosure relates to 3D image editing.

### 2. Description of Related Art

As the quality, efficiency, and accessibility of neural 3-Dimensional (3D) scene representations improve, interest in editing such representations has grown as well. Recent methods for text-guided 3D scene translation iteratively alter a set of source images, to which a neural radiance field (NeRF) is fit.

The advent of neural representations for 3D scenes has impacted a number of tasks in computer vision and graphics, from view synthesis to robotics. The accessibility of such representations is growing, as computational requirements are decreasing for both training (fitting) and inference (rendering).

In the near future, 3D scene representations may be readily available, even to non-technical users on consumer-grade devices. In particular, this could include neural radiance fields (NeRFs) or Gaussian splatting clouds. With this form of media, one important task for users is therefore 3D scene editing, analogous to the common operations used for decades on 2D images, such as inpainting, super-resolution, style transfer, and other generative alterations, which are useful for artistic content creation.

Existing models have difficulty consistently editing 3D images, because edits can be inconsistently applied to different views of the image.

### SUMMARY

According to an example embodiment, a method of editing a three-dimensional (3D) image, may include: acquiring a 3D image based on a plurality of two-dimensional (2D) images; receiving an input for editing the 3D image; editing a first 2D image among the plurality of 2D images based on the input, to generate an edited first 2D image; generating a synthetic 2D image from a viewpoint of a second 2D image of the plurality of 2D images, by projecting pixels of the edited first 2D image to locations corresponding to the viewpoint of the second 2D image; editing the second 2D image based on the input and the synthetic 2D image, to generate an edited second 2D image; and generating an edited 3D image based on the edited first 2D image and the edited second 2D image.

According to an example embodiment, an electronic device for editing a three-dimensional (3D) image, may include: at least one processor; and memory storing instructions that, when executed by the at least one processor, cause the at least one processor to: acquire a 3D image based on a plurality of two-dimensional (2D) images; receive an input for editing the 3D image; edit a first 2D image among the plurality of 2D images based on the input, to generate an edited first 2D image; generate a synthetic 2D image from a viewpoint of a second 2D image of the plurality of 2D images, by projecting pixels of the edited first 2D image to locations corresponding to the viewpoint of the second 2D image; edit the second 2D image based on the input and the synthetic 2D image, to generate an edited second 2D image; and generate an edited 3D image based on the edited first 2D image and the edited second 2D image.

According to an example embodiment, a non-transitory computer-readable storage medium, having a computer program stored thereon that performs, when executed by at least one processor: acquiring a 3D image based on a plurality of two-dimensional (2D) images; receiving an input for editing the 3D image; editing a first 2D image among the plurality of 2D images based on the input, to generate an edited first 2D image; generating a synthetic 2D image from a viewpoint of a second 2D image of the plurality of 2D images, by projecting pixels of the edited first 2D image to locations corresponding to the viewpoint of the second 2D image; editing the second 2D image based on the input and the synthetic 2D image, to generate an edited second 2D image; and generating an edited 3D image based on the edited first 2D image and the edited second 2D image.

The input may be a text-based input. The method may further include: interpreting the text-based input using a neural network to generate an input interpretation. The first 2D image and the second 2D image may be edited based on the input interpretation.

The generating the synthetic 2D image may be further performed by: acquiring first scene depth information of the first 2D image from a viewpoint of the first 2D image; acquiring second scene depth information of the second 2D image from the viewpoint of the second 2D image; determining relative 3D locations of pixels in the first 2D image and the second 2D image based on the first scene depth information and the second scene depth information; and projecting the pixels of the edited first 2D image to the locations corresponding to the viewpoint of the second 2D image based on the relative 3D locations.

The editing the first 2D image and the editing of the second 2D image may be performed using a neural network.

The neural network may be a Denoising Diffusion Model.

The 3D image and the edited 3D image may be Neural Radiance Fields (NeRFs).

A viewpoint of the first 2D image may be adjacent to the viewpoint of the second 2D image.

The method may further include: generating a second synthetic 2D image from a viewpoint of a third 2D image of the plurality of 2D images, by projecting pixels of the edited second 2D image to locations corresponding to the viewpoint of the third 2D image; editing the third 2D image based on the input and the second synthetic 2D image, to generate an edited third 2D image; and generating the edited 3D image based on the edited first 2D image, the edited second 2D image, and the edited third 2D image.

The method may further include: editing the first 2D image based on the input multiple times, to generate a plurality of edited first 2D images; and using a neural network, selecting one of the plurality of edited first 2D images as the edited first 2D image.

The disclosed technology can provide many improvements, advancing both the quality and controllability of the translated scenes. First, instead of updating each image independently, compromising cross-view consistency, one or more embodiments can control the editing diffusion process via projective constraints, using the scene geometry. Second, the ambiguity of the prompt limits user control, as many possible outputs could semantically match the text. Embodiments can improve specificity by allowing the specification of a reference image, which enforces a desired appearance. Third, one or more embodiments can incorporate techniques for relevance control, enabling content-aware adjustment of edit intensity. Beyond controllability, this also improves consistency in less-edited regions, and naturally fits within one or more embodiments of the generative constraint framework. In addition, one or more embodiments can devise a more comprehensive evaluation of the scene translation problem, decomposing quality assessment along three axes: rendered image quality, preservation of the original scene, and semantic correctness. One or more embodiments can not only improves these criteria, but also enable controlling their trade-off.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of a device according to one or more embodiments;

FIG. 2 is a flow chart of a method according to one or more embodiments;

FIG. 3 is a flow chart of a method according to one or more embodiments;

FIG. 4 is a flow chart of a method according to one or more embodiments;

FIG. 5 is a flow chart of a method according to one or more embodiments;

FIG. 6 shows views a 3D image based on a plurality of 2D images, according to one or more embodiments;

FIG. 7 shows a plurality of first edited 2D images according to one or more embodiments;

FIG. 8 shows views of reprojection according to one or more embodiments; and

FIG. 9 is a flow chart of a method of reprojection according to one or more embodiments.

### DETAILED DESCRIPTION

Hereinafter, the disclosure is described in detail with reference to the accompanying drawings.

General terms that are currently widely used are selected as possible as terms used in embodiments of the disclosure in consideration of their functions in the disclosure, and may be changed based on the intention of those skilled in the art or a judicial precedent, the emergence of a new technique, or the like. In addition, in a specific case, terms arbitrarily chosen by an applicant may exist. In this case, the meanings of such terms are described in detail in corresponding descriptions of the disclosure. Therefore, the terms used in the disclosure need to be defined based on the meanings of the terms and the content throughout the disclosure rather than simple names of the terms.

In the disclosure, an expression “have,” “may have,” “include,” “may include,” or the like, indicates the existence of a corresponding feature (for example, a numerical value, a function, an operation, or a component such as a part), and does not exclude the existence of an additional feature.

Expressions, “at least one of A and B” and “at least one of A or B” and “at least one of A or B” should be interpreted to mean any one of “A,” “B,” “A and B,” or variations thereof. As another example, “performing at least one of steps 1 and 2” or “performing at least one of steps 1 or 2” means the following three juxtaposition situations: (1) performing step 1; (2) performing step 2; (3) performing steps 1 and 2. Expressions “first,” “second,” and the like, used in the specification may indicate various components regardless of the sequence and/or importance of the components. These expressions are used only to distinguish one component from another component, and do not limit the corresponding components.

When any component (for example, a first component) is mentioned to be “(operatively or communicatively) coupled with/to” or “connected to” another component (for example, a second component), it is to be understood that any component may be directly coupled to another component or may be coupled to another component through still another component (for example, a third component).

A term of a singular number may include its plural number unless explicitly indicated otherwise in the context. It is to be understood that a term “include,” “formed of,” or the like used in the application specifies the presence of features, numerals, steps, operations, components, parts, or combinations thereof, mentioned in the specification, and does not preclude the presence or addition of one or more other features, numerals, steps, operations, components, parts, or combinations thereof.

Elements described as “modules” or “part” may be physically implemented by analog and/or digital circuits including one or more of a logic gate, an integrated circuit, a microprocessor, a microcontroller, a memory circuit, a passive electronic component, an active electronic component, and the like.

In the specification, such a term as a “user” may refer to a person who uses an electronic apparatus or an apparatus (for example, an artificial intelligence electronic apparatus) which uses an electronic apparatus.

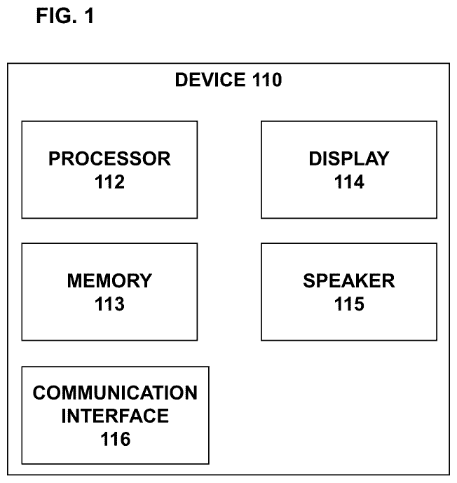

FIG. 1 is a block diagram of a device 110 according to one or more embodiments. The device 110 may include at least one processor 112 and at least one memory 113. The at least one memory 113 may store instructions or software configured to cause the at least one processor 112 to perform the methods described herein. The device 110 may be a server, smartphone, personal computer, wearable, tablet, neural implant, or other suitable device.

The device 110 may be a dedicated computing device communicating over a network with several user devices. The device 110 may be implemented by a plurality of servers, server units, or sub-servers (i.e. more than one computer) that may be directly connected electronically or connected over a network. In some embodiments, the device 110 includes display 114 and speaker 115 to implement a user interface. In some embodiments, the device 110 includes communication interface 116, and obtains an input and sends an output via communication interface 116.

Embodiments herein provide image modification device and method. These can be implemented on a device 110 alone, or with multiple devices acting in concert. For example, the device 110 may accept inputs (e.g. queries) from a user, and forward those queries using communication interface 116 to server for processing. Alternatively, device 110 may be a server that accepts user inputs directly or through a user device. Device 110 may implement a machine learning (ML) model or large language model (LLM) using the at least one processor 112 and at least one memory 113. Device 110 may generate an output in response to the input and forward the output using communication interface 116. The output may be an edited image as described with respect to one or more embodiments herein.

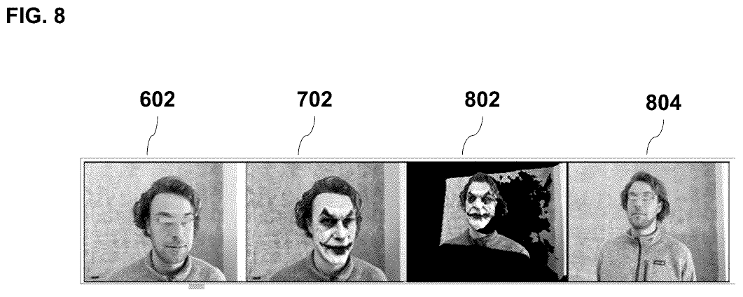

In one or more embodiments, the disclosure can provide 3D scene translation, wherein a scene is visually altered in accordance with some desired semantics (see FIG. 8). In contrast to conditional image generation based on semantic maps alone, the disclosed technology can preserve content or structure from an initial scene. This can be performed in 2D image-to-image (I2I) translation models, where the semantics are often encoded implicitly, based on the datasets employed (so-called “domain translation”). Some I2I translation approaches employ text-guided generative editing techniques. For instance, an Instruct-Pix2Pix (IP2P) model can map an image (to be modified) and a text command (specifying how to change the image) to a translated output image. It is also related to style transfer, though the goal in that case is matching the “textural statistics” of an example image, rather than satisfying some form of semantic specification (e.g., text), as in one or more embodiments herein.

An example of 3D translation, Instruct-NeRF2NeRF (IN2N), introduced a technique for continuously altering a NeRF, called iterative dataset update (IDU). Building on a text-guided I2I translation model operating in 2D, specifically IP2P. the set of “source images” to which the NeRF is fit can be iteratively updated, such that continuously running the fitting process evolves both the sources and the NeRF itself. To provide 3D feedback to the 2D translator, the NeRF renders are used as the starting point for the diffusion-based editing process. The result, ideally, converges to a view-consistent translated 3D scene.

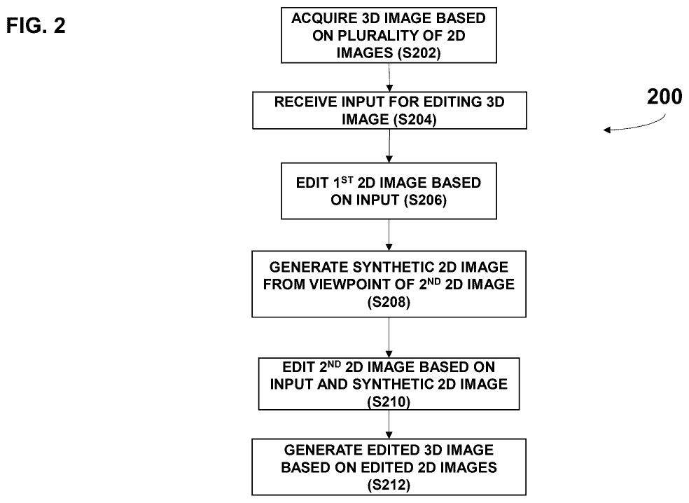

However, there are some limitations to using the straightforward form of IDU for 3D translation. First, there is limited controllability, due to ambiguity in the desired semantics: since the source images are stochastically changing throughout the process, the user does not know which instantiation of a concept will appear until the edit has finished (i.e., IDU has converged). For instance, the IP2P command “Turn him into Superhero” has a plethora of equally valid outputs for a given person, yet which will be chosen is effectively up to luck. Second, in IN2N, each image is updated in a manner that is only indirectly aware of the other source images (via the use of the NeRF render as a diffusion starting point); thus, the independent editing processes are likely to be 3D inconsistent (see FIG. 2). In other words, this constraint is relatively weak and cannot ensure multiview consistency in the source images, which results in lower image quality when the NeRF attempts to merge such inconsistencies.

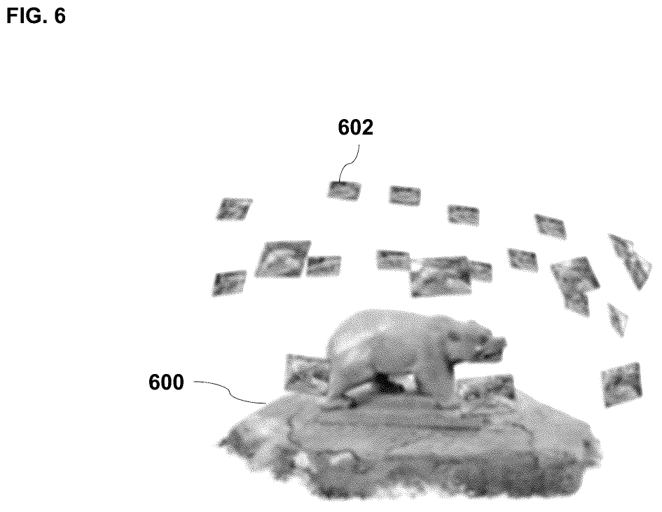

FIG. 6 shows views of a 3D image 600 based on a plurality of 2D images 602, according to one or more embodiments. 3D image 600 may be a NeRF image. 3D image 600 may be a function generated by a neural network based on a plurality of 2D images 602 taken from different views. Using the 2D images 602 and the known view positions of the 2D images 602, the neural network can generate a function for a 3D image, whereby synthetic 2D images are generated for any given view that is not represented in the initial 2D image input set.

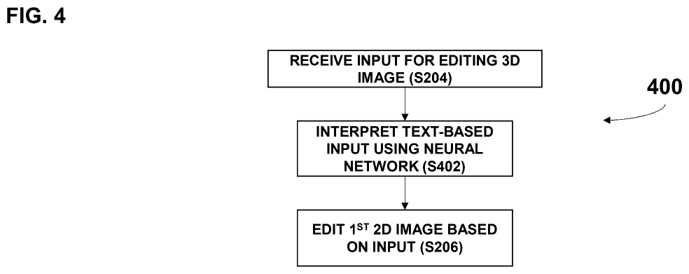

FIG. 2 is a flow chart of a method 200 according to one or more embodiments. The method 200 may be performed by device 110. In particular, a 3D image 600 based on a plurality of 2D images 602 is acquired (S202). This 3D image 600 may be a NeRF image. It is important to note that although the 2D images 602 are referred to herein as “2D images,” the 2D images 602 may contain depth data. Next, an input for editing the 3D image 600 is received (S204). This input may be a text-based input from a user. For example, the user may instruct the device 110 to convert a NeRF self-portrait into a clown, by saying “turn me into a clown.” FIG. 4 shows a method 400 of handling a text-based input. In operation S402, the text-based input is interpreted using a neural network. The editing instructions may come from a machine or software rather than a human user.

As discussed above, a satisfactory way of editing a 3D image in this manner does not currently exist, because the different 2D image views will be edited inconsistently. To address this problem, one or more embodiments edit a first 2D image 602 based on the user input (S206), instead of attempting 3D editing or editing all of the 2D images in the input set. To provide consistency editing, a single 2D image 602 can be edited first and used as a basis for editing other 2D images 602 forming the 3D image 600. According to one or more embodiments, the image editing may be performed using a neural network. In one or more embodiments, the neural network is a Denoising Diffusion Model.

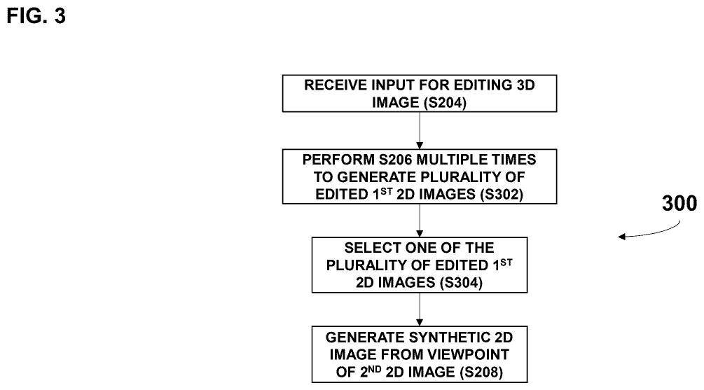

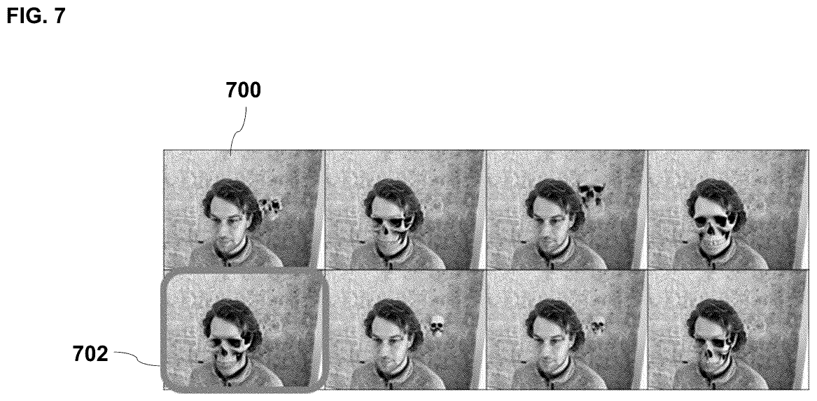

At this stage, a plurality of edited first 2D images may be generated, as shown in FIGS. 3 and 7 (method 300). This is achieved by performing S206 multiple times to generate the plurality of edited first 2D images (S302). As shown in FIG. 7, the same 2D image view is used to generate multiple edited 2D images 700. In the case of FIG. 7, the user may have instructed the software to “make me into a skull.” Either the user or the software (using e.g. artificial intelligence), can select a best or preferred edited 2D image 702 (S304). The selected edited first 2D image 702 is used as a basis for editing the entire 3D image.

Editing the 3D image 600 based on the edited first 2D image 702 is performed according to the following. Specifically, a second viewpoint other than the first viewpoint of the edited first 2D image is selected. This second viewpoint may be adjacent (i.e. within 30degrees) of the first viewpoint of the edited first 2D image 702. The second viewpoint may also be the nearest neighbor to the first viewpoint in the 2D image dataset.

FIG. 8 shows different images used in this process. In FIG. 8, the single 2D image 602 is shown on the left. The single 2D image 602 is edited according to input to generate edited first 2D image 702. Second 2D image 804 in FIG. 8 is an example of a 2D image showing the 3D image from the second viewpoint. The software uses the edited first 2D image 702 to generate a synthetic image 802 from the second viewpoint (S208). As can be seen in FIG. 8, synthetic image 802 resembles second 2D image 804, but with the clown editing.

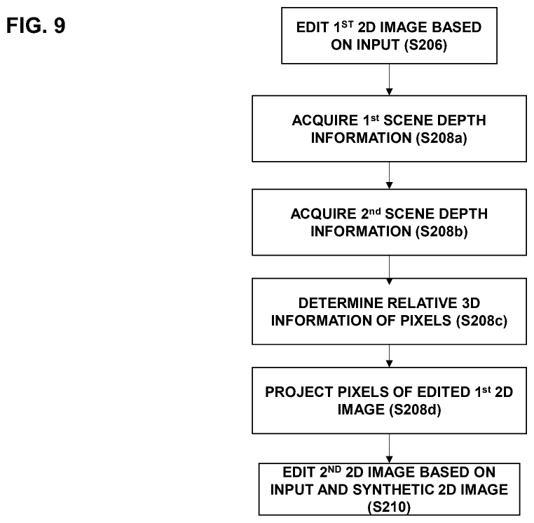

Synthetic image 802 is generated using the scene depth and viewpoint data from both first 2D image 602 and second 2D image 804. With this data, pixels from the edited first 2D image 702 are reprojected from the second viewpoint. As shown in FIG. 9, operation S208 can be performed by a plurality of sub-operations. First scene depth information of the first 2D image 602 from a viewpoint of the first 2D image 602 is acquired (S208a). Second scene depth information of the second 2D image 804 from the viewpoint of the second 2D image 804 is acquired (S208b). Relative 3D locations of pixels in the first 2D image 602 and the second 2D image 804 are determined based on the first scene depth information and the second scene depth information (S208c). The pixels of the edited first 2D image 702 are projected to the locations corresponding to the viewpoint of the second 2D image based on the relative 3D locations (S208d).

As can be seen in the synthetic image 802, certain pixels (represented in black) are absent from the synthetic image because those pixels are not visible from the first viewpoint. Accordingly, synthetic image 802 is incomplete. Generally, the closer the second viewpoint is to the first viewpoint, the more complete synthetic image 802 will be.

Next, the second 2D image 804 is edited in a similar manner as the first 2D image, but with both the initial editing input and the synthetic image 802 used as constraints to the editing process (S210). Because the synthetic image 802 (which is based on the edited first 2D image 702) is used as a constraint for editing the second 2D image 804, the editing of the second 2D image 804 will be consistent with the editing of the first 2D image 602. In other words, instead of an arbitrary clown modification being performed on second 2D image 804, a similar clown modification will be performed as was done on the first 2D image 602.

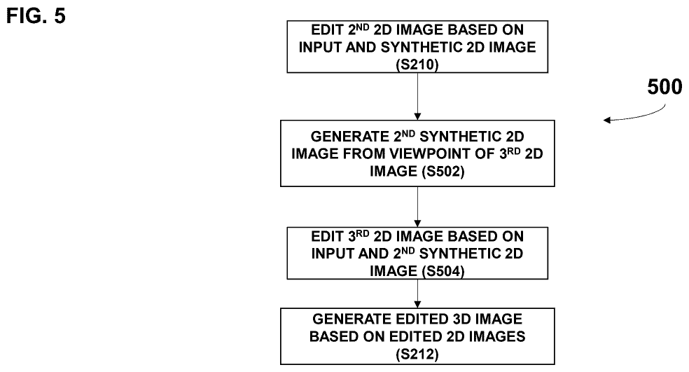

This process can be repeated for other viewpoints of the 3D image, as set forth in FIG. 5 (method 500). A second synthetic 2D image can be generated from a third viewpoint of a third 2D image (S502). The third 2D image can be edited based on the input and the second synthetic 2D image to create an edited third 2D image (S504).

Once the edited 2D images are created from multiple views, a 3D image is created based on those edited 2D images (S212). The edited 3D image should resemble the edited first 2D image, but be 3D and viewable from multiple viewpoints. The edited 3D image may be a NeRF.

One or more embodiments can mitigate shortcomings of existing methods by modifying the IDU process. To improve controllability, specification of a translated reference image is allowed, which has the desired scene appearance from one viewpoint. This reduces the ambiguity (i.e., the space of possible output translations) induced by using text alone. A simple heuristic for automatically choosing a reference translation is provided, retaining ease of use and explorability. To strengthen the multiview consistency constraint in the independent 2D source updates, a potential function is provided, which modifies the diffusion process to take other source images into account. This mechanism utilizes the depth and camera information in the evolving scene to project appearance information through space, resulting in improved 3D consistency. This results in better image quality as well, since increased consistency leads to fewer NeRF artifacts and reduced blurriness. As such, one or more embodiments have more generally enhanced the quantitative evaluation from some 3D translation studies to more comprehensively assess original scene preservation, semantic matching, and the quality of rendered images. In some embodiments, the disclosed technology can include (i.e., but is not limited to):

(1) One or more embodiments enable image-based control over the 3D scene translation process, using a reference image to specify which instantiation of a probabilistic edit is desirable.

(2) One or more embodiments provide a “reprojective” mechanism for injecting 3D-aware guidance into a 2D diffusion model, without additional training or fine-tuning, designed specifically for 3D scene translation.

(3) One or more embodiments naturally integrate approaches for automatic edit localization into one or more embodiments of the multiview diffusion guidance approach, enabling content-aware control over the level of preservation of the original scene.

(4) One or more embodiments provide a metric for evaluating the semantic matching between the model outputs and the desired translation, utilizing 2D image translations in a way that more closely mimics the expectations of a user.

(5) Despite its increased versatility (i.e., controllability), one or more embodiments still perform well at balancing the major requirements for translation (semantic similarity, preservation, and image quality), outperforming existing baselines.

### Algorithms

### Diffusion Generative Modelling

One or more embodiments can perform Diffusion Generative Modelling. For example, one or more embodiments can learn a [symbol] -valued stochastic process, Xₜ, that traverses between a data distribution, X₀˜q(X₀), and a simple prior, X₁˜ [symbol] (0, l) (e.g.,). If the forward (noising/inference) process is given by a stochastic differential equation (SDE) written in Itô form (e.g.,) via dXₜ=f(Xₜ, t)dt+g(t)dWₜ, then the reverse (denoising/generation) process is given by:

$$d {X}_{t} = [ f ( {X}_{t} , t ) - {g ( t )}^{2} s ( {X}_{t} , t ) ] dt + g ( t ) d {W}_{t} \qquad EQN ( 1 )$$

where time is reversed and s(Xₜ, t):=∇_{X}_{ₜ}logqₜ(Xₜ) is the score. In the “variance-preserving” case. the coefficients are given by f(Xₜ, t)=−βₜXₜ/2 and g(t)=\sqrt{βₜ}, where βₜ∈[0,1] is a schedule of noise scales. Then, the Denoising Diffusion Probabilistic Model (DDPM) is the Euler-Maruyama discretization of EQN (1). Access to a pretrained noise estimation model, \hat{ϵ}_{θ}(Xₜ, t) can be assumed, which relates closely to the score via s(Xₜ, t)≈−σₜ⁻¹\hat{ϵ}_{θ}(Xₜ, t), where

$${σ}_{t} = 1 - exp ( - {\int }_{0}^{t} {β}_{s} d s ) .$$

In practice, for sampling, one or more embodiments use the Denoising Diffusion Implicit Model (DDIM) discretized solver:

$${X}_{t - 1} = \sqrt{{α}_{t - 1}} {\hat{X}}_{0 \vert t} ( {X}_{t} ) + \sqrt{1 - {α}_{t - 1} - {η}_{t}^{2}} {\hat{ϵ}}_{θ} ( {X}_{t} , t ) + {η}_{t} {ξ}_{t} \qquad EQN ( 2 )$$

where αₜ=1−βₜ, ξₜ˜ [symbol] (0,l) is independent from Xₜ, \hat{X}_{0|t}(Xₜ)=E[X₀|Xₜ]∈Z is the Tweedie posterior mean (e.g.,), and ηₜ is a stochasticity scale, interpolating between the estimated and sampled noise, which can be set to zero. In the discretized case, the expectation is given by \hat{X}_{0|t}(Xₜ)=(Xₜ−\sqrt{1−\hat{α}ₜ}\hat{ϵ}_{θ}(Xₜ, t)/\sqrt{α̅ₜ}, where

$${\overline{α}}_{t} = {\prod }_{s = 1}^{t} {α}_{s} .$$

For generative editing, a latent diffusion model can be considered. with an encoder, ε: [symbol] → [symbol] , and decoder, [symbol] : [symbol] → [symbol] . In this case, Î_{0|t}(Xₜ)= [symbol] (\hat{X}_{0|t}(Xₜ) is a differentiable “single-step” estimate of the output generation at any intermediate time point in the process.

EQN (1) can be used for inverse problems, by including additional constraints. In particular, the reverse process is similar to gradient descent via the score function, where \hat{ϵ}_{θ} acts as a gradient estimator, to satisfy the Bayesian prior. Thus, to impose constraints on the output, one or more embodiments can alter the likelihood being maximized (modifying EQN (2)). In particular, instead of s(Xₜ, t)=∇_{X}_{ₜ}logqₜ(Xₜ), one or more embodiments follow s(Xₜ, t|y)=∇_{X}_{ₜ}logqₜ(Xₜ|y), for some condition y. But, this can be written ∇_{X}_{ₜ}logqₜ(Xₜ|y)=∇_{X}_{ₜ}logqₜ(Xₜ)+∇_{X}_{ₜ}Φ(y|Xₜ), where Φ(y|Xₜ)=logqₜ(y|Xₜ) is a guidance potential. One or more embodiments provide a Φ to encourage multiview consistency and control content-dependent preservation of the original scene. Using Φ(y|Xₜ)=\tilde{φ}(Î_{0|t}(Xₜ), y) allows defining constraints in image space, rather than in a noisy or latent space.

One or more embodiments can use Instruct-Pix2Pix (IP2P) to modify 2D images in the 3D image. Given an image, I∈ [symbol] , one or more embodiments translate it according to a text instruction, C_{T}. IP2P is a conditional diffusion model, using classifier-free guidance to generate an image based on I, but following the semantics of C_{T}: Ê=IP2P(I, C_{T}, w_{T}, w_{I})∈ [symbol] , where w_{T} and w_{I} weight the guidance towards C_{T} and I, respectively. This is implemented through a learned latent-space denoiser, ϵ_{θ,IP2P}(Xₜ, t|w_{T}, w_{I}).

One or more embodiments can be used to modify Neural Radiance Fields (NeRFs). For example, let

$$S = {\{ ( {I}_{j} , {Π}_{j} ) \}}_{j = 1}^{{N}_{v}} ⊂ 𝒥 \times {𝒫}_{Π}$$

be a posed image set, where [symbol] is the space of camera parameters. A NeRF, denoted [symbol] _{φ} (with learned parameters, φ), provides continuous fields for density and colour, which can be rendered to depth and colour images, respectively. Specifically, the volumetric rendering operator (e.g., see) maps Π∈ [symbol] _{π} and [symbol] _{φ} to a colour image, [symbol] _{c}(Π, φ)∈ [symbol] , or depth image, [symbol] _{d}(Π, φ)∈ [symbol] _{D}.

Iterative Dataset Update (IDU) can also be used to edit 3D images, with some modification. The IN2N algorithm provides an elegant approach to translating 3D NeRF scenes, via IP2P. In particular, a NeRF is trained on a multiview source dataset,

$$S = {\{ ( {I}_{j , k ( i )} , {Π}_{j} ) \}}_{j = 1}^{{N}_{v}} ,$$

which is iteratively updated during the training process, for i∈{0, 1, . . . } and k(0)=0. Specifically, every nᵢ iterations of NeRF fitting, a single source image is updated for the ath time via I_{j,a}=IP2P(I_{j,0}, C_{T}, w_{T}, w_{I}|tₛ, \hat{R}ⱼ), where \hat{R}ⱼ=ε( [symbol] _{c}(Πⱼ, φ)) is the start-point and tₛ∈ [symbol] [0,1] is the start-time, for the editing diffusion process. The result is a NeRF, [symbol] _{φ}_{_{T}}, fit to the source set, Sₖ, that slowly changes from its original visual form into a translated scene, as Sₖ is updated.

One example approach of the disclosed technology is to build on the iterative dataset update (IDU) algorithm, but provide several changes. First, one or more embodiments use a reference image, which improves controllability and anchors the editing process to a specific instantiation of the visual semantics. Second, one or more embodiments apply constraints on the image-to-image diffusion process that updates each source image, expressing cross-view dependencies. Third, one or more embodiments incorporate soft “relevance control,” naturally integrating “content-dependent” edit strength into a 3D-aware diffusion guidance. In combination, one or more embodiments result in a straightforward modification of the IN2N process, which one or more embodiments show improves controllability and quality for 3D scene translation.

Following the notation in background section, one or more embodiments begin with a posed multiview image set of a scene,

$${S}_{0} = {\{ ( {I}_{j , 0} , {Π}_{j} ) \}}_{j = 1}^{{N}_{v}} .$$

As in IN2N, one or more embodiments assume a NeRF, [symbol] _{φ}, (pretrained on S) is already given. Further, one or more embodiments have as input a text instruction, C_{T}, and optionally a reference image, I_{ref}. Together, these two inputs specify the semantics of the translation. One or more embodiments can produce a new NeRF, [symbol] _{φ}_{_{T}}, which has been visually modified to match the semantics in C_{T} (and I_{ref}, if chosen). One or more embodiments follow the IDU approach of IN2N, repeatedly altering each I_{j,i} via IP2P. Finally, one or more embodiments allow one more optional input: per-view soft “relevance” masks for the source images (also called “editing masks”),

$${ℳ}_{R} = {\{ {ℳ}_{R , j} \}}_{j = 1}^{{N}_{v}} ⊂ {𝒥}_{[ 0 , 1 ]} ,$$

where [symbol] _{[0,1]} is the set of single-channel images with pixels in [0,1]. These masks take high values at pixels that are relevant to C_{T} and hence should be edited (i.e., altered by the translation); conversely, pixels with low mask values should be preserved. Note that I_{ref} and [symbol] _{R} will be automatically computed from S₀ and C_{T}, if they are not specified. Finally, one or more embodiments use [symbol] _{φ} to precompute depth maps of the original scene,

$$D = {\{ {D}_{j} \}}_{j = 1}^{{N}_{v}} ,$$

with Dⱼ:= [symbol] _{d}(Πⱼ,φ).

Diffusion-based editing models can generate many different outputs for the same input. The current formulation for IN2N does not enable a user to choose which of these solutions is desirable. To enable this controllability, one or more embodiments specify an initial edited reference image, I_{ref}, with a camera pose, Π_{ref}, which will determine the visual semantics of the 3D scene from that viewpoint. The reference translation is obtained before any other source image is changed, as further translations will be based on it.

To select a reference translation, one or more embodiments can translate a random subset of ten views, and choose the view with the highest CLIP similarity to the text instruction, C_{T}. One or more embodiments then translate the same view six times and choose the best result, in terms of CLIP similarity. While this is a straightforward heuristic, it helps avoid cases where the diffusion model (IP2P) makes insufficient changes to the source image. It also makes manual reference specification optional, thus retaining comparability to other methods, in that ours does not require additional inputs. One or more embodiments use an automatic selection process, unless otherwise specified.

To enforce the visual specifications of the reference image, one or more embodiments can include losses at each training iteration that target only the reference source image. Furthermore, one or more embodiments can ensure that every fitting iteration devotes a portion of sampled rays to the reference, with the remainder sampled randomly from the full source set. In particular, one or more embodiments can apply the following objective to learning the NeRF weights, φ_{T}:

$${ℒ}_{ref} ( {ϕ}_{T} ) = {γ}_{r , c} {‖ {I}_{ref} - {ℛ}_{c} ( Π , {ϕ}_{T} ) ‖}_{1} + {γ}_{r , d} {d}_{rank} ( {\hat{D}}_{ref} , {d}_{m o n o} ( {I}_{ref} ) ) + {L}_{P} ( {ℳ}_{R , ref} , {D}_{ref} , {\hat{D}}_{r e f} ) \qquad EQN ( 3 )$$

where \hat{D}_{ref}= [symbol] _{d}(Π, φ_{T}) is the current depth, L_{P}(M, d₁, d₂)=w_{P}∥(1−M)⊙(d₁−d₂)∥₁ is a weighted geometric preservation loss, dₘₒₙₒ is a monocular depth estimator. and dᵣₐₙₖ is the depth ranking loss. As is standard in NeRFs, at each step, one or more embodiments only sample a subset of pixel rays, at which this loss is evaluated (via the sampled colours, relevances, and depths).

As noted above, one or more embodiments can define a potential function, Φ, designed to explicitly encourage (i) multiview consistency among the source images and (ii) preservation of original source image areas that are not relevant to the edit. Whenever IP2P is used to construct a new source image, this potential is used to modify the trajectory of the diffusion process. Suppose one or more embodiments are used to generate (e.g., translate) a target source view, (I, Π)∈Sₖ. First, a subset of source images, Γ⊂Sₖ is chosen, with which the output, I is asked to be consistent. To encourage multiview consistency, one or more embodiments apply the following reprojective potential to alter Xₜ:

$${Φ}_{M V} ( Γ \vert {X}_{t} ) = \frac{1}{\vert Γ \vert} {\sum }_{ℓ = 1}^{\vert Γ \vert} {w}_{MV , t} {\vert \vert {𝒥}_{ℓ , t} ⊙ [ {g}_{t} ( {r}_{ϕ , Π , {Π}_{ℓ}} ( {I}_{ℓ} ) ) - {g}_{t} ( {\hat{I}}_{0 \vert t} ( {X}_{t} ) ) ] \vert \vert}_{2}^{2} \qquad EQN ( 4 )$$

where (Iₗ, Πₗ)∈Γ, w_{MV,t}∈ [symbol] ₊, gₜ is a time-dependent Gaussian blur. Î_{0|t}(Xₜ) is the one-step Tweedie prediction of the output, r_{φ,Π,Π}_{ₗ} is the pixel reprojection operator (which uses the current NeRF depth and camera information to compute corresponding pixel locations between views), and [symbol] is the reprojection mask (which is a binary image identifying reprojective mismatches, such as occluded or off-image pixels). One or more embodiments linearly anneal the standard deviation of gₜ from σₘₐₓ to 0, as well as the value of w_{MV,t} from 0 to w_{MV,max}, as t goes from 1 to 0, similar to some approaches.

The second term of potential is concerned with the preservation of “irrelevant” areas of the source image. This relates closely to multiview consistency: in areas that are not necessary to change, one or more embodiments can preserve the original scene structure, which should be 3D consistent (assuming it comes from real photos), eliminating an opportunity for cross-divergence in the translation process. Hence, using the relevance masks can encourage preservation. Specifically, let Ĩ denote the original source image corresponding to the target (i.e., when the jth source is the target, Ĩ=I_{j,0}). Then, one or more embodiments encourage preservation via:

$${Φ}_{P} ( \tilde{I} \vert {X}_{t} ) = {γ}_{P} \vert \vert ( 1 - \tilde{ℳ} ) ⊙ [ \tilde{I} - {\hat{I}}_{0 \vert t} ( {X}_{t} ) ] \vert {\vert}_{2}^{2} \qquad EQN ( 5 )$$

where γ_{P}∈ [symbol] ₊ weights the strength of the preservation potential and [symbol] is the relevance map corresponding to Ĩ.

The full energy function is then Φ(Γ, Ĩ|Xₜ)=Φ_{MV}(Γ|Xₜ)+Φ_{P}(Ĩ|Xₜ). After each step in the denoising (reverse) diffusion process (i.e., following the generative prior), one or more embodiments take nₚₛ gradient descent steps on Xₜ, via ∇_{X}_{ₜ}Φ (akin to “splitting”; e.g., see). The IP2P DDIM process for each IN2N source update is otherwise unchanged.

The relevance (editing) masks, [symbol] , modify both the source images (by altering the IP2P updates through a guidance potential) and the NeRF itself (by changing its losses).

Whenever masks are not manually specified, following some approaches on mask computation from diffusion models, one or more embodiments compute soft relevance maps via the normalized absolute difference between two IP2P noise estimates: using C_{T} versus an empty text string. One or more embodiments have (at least) two major differences with existing localizers: (i) guidance potential operates in image-space, not the low-dimensional latent space, and (ii) there is no hard binarization (thresholding) utilized. These can reduce certain blocky artifacts incurred by relevance boundaries appearing inside the patches corresponding to a single latent pixel value. As for choosing the reference image, the automatic mask procedure means specifying [symbol] is optional for a user.

Drawing on some approaches, specifically WYS, one or more embodiments augment the NeRF to output relevance values as well, trained via the standard MSE loss on [symbol] . This combines relevance estimates from multiple views, leading to reduced noise and clearer boundaries. Rather than using M∈ [symbol] , one or more embodiments can instead use the relevance field render.

One or more embodiments are capable of performing Multiview Consistent Iterative Dataset Updates (MCIDU), enabling consistent 3D image editing. The use of reprojective guidance and the presence of a reference image warrants alteration of the source update procedure of IN2N. In particular, one or more embodiments can (i) prevent the reference image from being translated in a source update and (ii) use the camera distance from the reference view to order the updates to the sources. One or more embodiments can therefore consider the set of sources to be an ordered list: (I_{ref}, I₁, . . . , I_{N}_{ᵥ}). To choose the subset, denoted Γ, used by Φ_{MV} to update Iₖ, one or more embodiments can consider only the images in (I_{ref}, I₁, . . . , Iₖ₋₁), and take the |Γ| images that are closest to Iₖ in terms of camera distance. This results in the reprojective sources in Γ being updated more recently than Iₖ, and naturally encourages the “spread” of information from I_{ref}.

Recall that IN2N uses both an L₁ pixelwise loss and a perceptual loss (LPIPS). In addition, since access to the relevance masks (via the relevance field) is assumed, it can be used to preserve unmasked geometry. Thus, one or more embodiments can compute:

$${ℒ}_{m a i n} ( {ϕ}_{T} ) = {ℒ}_{I N 2 N} ( {ϕ}_{T} ) + {L}_{P} ( ℳ , D , \hat{D} ) + {L}_{rel} ( {ϕ}_{T} ) \qquad EQN ( 6 )$$

where [symbol] _{IN2N}(φ_{T}) are the reconstruction losses used by IN2N, Lᵣₑₗ(φ_{T}) trains the relevance field, and L_{P} is the same preservation loss as before, except the rays are sampled from all views in the current sources, such that [symbol] , D, and \hat{D} are the relevances (from the relevance field), original depths, and current rendered depths, respectively, of those samples. Per fitting iteration, the final loss combines this loss with the reference-based one: [symbol] (φ_{T})= [symbol] _{ref}(φ_{T})+ [symbol] ₘₐᵢₙ(φ_{T}).

One or more embodiments can utilize the same 3D scene test data and settings as IN2N. which comprises ten scenarios (instructions): seven with the face and three with the bear scene.

One or more embodiments evaluate three aspects of [symbol] _{φ}_{_{T}}: semantic closeness to C_{T}, image quality of the renders, and preservation of the initial scene ( [symbol] _{φ}). One or more embodiments utilize three semantic metrics based on some approaches all computed in CLIP-space. Edit Consistency (EC) measures the change in edit direction across adjacent frames. CLIP directional score (CDS) measures how changes in text captions agree with changes in images, using manually defined text prompts. Finally, text-image similarity (TIS) directly measures similarity to C_{T} via CLIP. However, these measures do not consider the image-space translation distribution defined by IP2P itself. One or more embodiments therefore define a translation matching (TM) metric: TM_{d}_{_{I}}=medianᵢmin_{I}_{_{i,j}}_{∈T}_{_{S,i}}d_{I}(I_{i,j}, fᵢ), where d_{I} is a semantic distance metric on images, fᵢ is the ith render from [symbol] _{φ}_{_{T}} on some camera path, and T_{S,i} is a set of IP2P translations of f_{i,0} (rendered from [symbol] _{φ}). One or more embodiments consider two choices for d_{I}, based on CLIP and DreamSim (DS). To measure image quality, one or more embodiments use two no-reference metrics, NIQE and MUSIQ. Since inconsistencies tend to exacerbate blur, one or more embodiments also measure sharpness using the Laplacian filter response (as in, e.g.,). Finally, one or more embodiments compute two simple measures of scene preservation: (i) peak signal-to-noise ratio (PSNR) between renders from [symbol] _{φ} and [symbol] _{φ}_{_{T}}, and (ii) semantic preservation (Sem-Pres) via CLIP.

A primary baseline is IN2N, upon which one or more embodiments build. One or more embodiments also consider a “gold standard” baseline, denoted IP2P-2D, which translates each 2D frame of the original NeRF, [symbol] _{φ}. Thus, notice that IP2P-2D has no 3D structure to enforce multiview consistency. Finally, one or more embodiments compare to Watch Your Steps (WYS). which proposes 3D relevance fields. WYS uses a binary threshold on the editing masks, where unmasked latent features above the threshold can change arbitrarily, while those below it cannot change at all. As such, WYS severely constrains IP2P from making changes it ordinarily may have done, and may be more reliant on high quality maps. Finally, compared to all baselines, one or more embodiments try to enforce reference-based controllability, which increases the difficulty of the task.

In some embodiments, the algorithms are tested with certain functionalities removed or modified. In some embodiments, the disclosed technology comprises three main components: (i) the reprojective consistency potential, (ii) preservation of the original scene via specified relevances, and (iii) reference specification and enforcement. One or more embodiments therefore consider three scenarios, where each of these three components are removed (no reprojection, no relevances, and no reference). Note that IN2N is a special case of one or more embodiments, when all three of (i-iii) are removed. Finally, one or more embodiments also consider a variation of one or more embodiments, just with slightly higher preservation.

In some embodiments, the disclosure includes an approach to 3D scene translation, building upon the recent IDU algorithm. By permitting specification of a reference image, one or more embodiments improve controllability of the ill-defined generative editing process. Further, one or more embodiments apply a reprojective consistency potential to encourage source updates to be 3D-aware. This enables additional controllability, with minimal loss in semantic conservation and image quality. It is contemplated that many variations associated with the disclosed technology are possible.

Embodiments of the method and device described herein improve the functioning of a computer by enabling consistent 3D image editing. These problems of inconsistent 3D image editing are present in the realm of computation and networks. Thus, embodiments herein are rooted in computer technology to overcome a problem arising in the realm of computer networks, for example.

Meanwhile, according to one or more embodiments of the disclosure, the various embodiments described above may be implemented with software including instructions stored in a machine-readable storage media (e.g., computer). The machine may call an instruction stored in a storage medium, and as an apparatus operable according to the called instruction, may include an electronic apparatus (e.g., electronic apparatus (A)) according to the above-mentioned embodiments. Based on a command being executed by a processor, the processor may directly or using other elements under the control of the processor perform a function relevant to the command. The command may include a code generated by a compiler or executed by an interpreter. The machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to one or more embodiments of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, according to one or more embodiments of the disclosure, the various embodiments described above may be implemented in a recordable medium which is readable by computer or an apparatus similar to computer using software, hardware, or a combination thereof. In some cases, the embodiments described herein may be implemented by the processor itself. According to a software implementation, embodiments such as procedures and functions described herein may be implemented with separate software modules. Each of the above-described software modules may perform one or more of the functions and operations described herein

Meanwhile, computer instructions for performing processing operations of the machine according to the various embodiments described above may be stored in a non-transitory computer-readable medium. The computer instructions stored in this non-transitory computer-readable medium may cause a specific device to perform the processing operations in the machine according to the above-described various embodiments when executed by the processor of the specific device. The non-transitory computer-readable medium may refer to a medium that stores data semi-permanently rather than storing data for a very short time, such as a register, a cache, a memory, or the like, and is readable by the machine. Specific examples of the non-transitory computer-readable medium may include, for example, and without limitation, a compact disc (CD), a digital versatile disc (DVD), a hard disc, a Blu-ray disc, a USB, a memory card, a ROM, and the like.

In addition, respective elements (e.g., a module or a program) according to various embodiments described above may be formed of a single entity or a plurality of entities, and some sub-elements of the above-mentioned sub-elements may be omitted or other sub-elements may be further included in the various embodiments. Alternatively or additionally, some elements (e.g., modules or programs) may be integrated into one entity to perform the same or similar functions performed by the respective relevant elements prior to integration. Operations performed by a module, a program, or other element, in accordance with the various embodiments, may be executed sequentially, in parallel, repetitively, or in a heuristically manner, or at least some operations may be performed in a different order, omitted, or a different operation may be added.

While certain embodiments of the disclosure has been particularly shown and described, it will be understood that various changes in form and details may be made therein without departing from the spirit and scope of the following claims.

What is claimed is:

1. A method of editing a three-dimensional (3D) image, the method comprising:
acquiring a 3D image based on a plurality of two-dimensional (2D) images;
receiving an input for editing the 3D image;
editing a first 2D image among the plurality of 2D images based on the input, to generate an edited first 2D image;
generating a synthetic 2D image from a viewpoint of a second 2D image of the plurality of 2D images, by projecting pixels of the edited first 2D image to locations corresponding to the viewpoint of the second 2D image;
editing the second 2D image based on the input and the synthetic 2D image, to generate an edited second 2D image; and
generating an edited 3D image based on the edited first 2D image and the edited second 2D image.

2. The method of claim 1, wherein the input is a text-based input, further comprising:
interpreting the text-based input using a neural network to generate an input interpretation,
wherein the first 2D image and the second 2D image are edited based on the input interpretation.

3. The method of claim 1, wherein the generating the synthetic 2D image is further performed by:
acquiring first scene depth information of the first 2D image from a viewpoint of the first 2D image;
acquiring second scene depth information of the second 2D image from the viewpoint of the second 2D image;
determining relative 3D locations of pixels in the first 2D image and the second 2D image based on the first scene depth information and the second scene depth information; and
projecting the pixels of the edited first 2D image to the locations corresponding to the viewpoint of the second 2D image based on the relative 3D locations.

4. The method of claim 1, wherein the editing the first 2D image and the editing of the second 2D image are performed using a neural network.

5. The method of claim 4, wherein the neural network is a Denoising Diffusion Model.

6. The method of claim 1, wherein the 3D image and the edited 3D image are Neural Radiance Fields (NeRFs).

7. The method of claim 1, wherein a viewpoint of the first 2D image is adjacent to the viewpoint of the second 2D image.

8. The method of claim 7, wherein the synthetic 2D image is a first synthetic 2D image, the method further comprising:
generating a second synthetic 2D image from a viewpoint of a third 2D image of the plurality of 2D images, by projecting pixels of the edited second 2D image to locations corresponding to the viewpoint of the third 2D image;
editing the third 2D image based on the input and the second synthetic 2D image, to generate an edited third 2D image; and
generating the edited 3D image based on the edited first 2D image, the edited second 2D image, and the edited third 2D image.

9. The method of claim 1, further comprising:
editing the first 2D image based on the input multiple times, to generate a plurality of edited first 2D images; and
using a neural network, selecting one of the plurality of edited first 2D images as the edited first 2D image.

10. An electronic device for editing a three-dimensional (3D) image, the electronic device comprising:
at least one processor; and
memory storing instructions that, when executed by the at least one processor, cause the at least one processor to:
acquire a 3D image based on a plurality of two-dimensional (2D) images;
receive an input for editing the 3D image;
edit a first 2D image among the plurality of 2D images based on the input, to generate an edited first 2D image;
generate a synthetic 2D image from a viewpoint of a second 2D image of the plurality of 2D images, by projecting pixels of the edited first 2D image to locations corresponding to the viewpoint of the second 2D image;
edit the second 2D image based on the input and the synthetic 2D image, to generate an edited second 2D image; and
generate an edited 3D image based on the edited first 2D image and the edited second 2D image.

11. The electronic device of claim 10,
wherein the input is a text-based input,
wherein the instructions further cause the at least one processor to interpret the text-based input using a neural network to generate an input interpretation, and
wherein the first 2D image and the second 2D image are edited based on the input interpretation.

12. The electronic device of claim 10, wherein the instructions further cause the at least one processor to generate the synthetic 2D image by:
acquiring first scene depth information of the first 2D image from a viewpoint of the first 2D image;
acquiring second scene depth information of the second 2D image from the viewpoint of the second 2D image;
determining relative 3D locations of pixels in the first 2D image and the second 2D image based on the first scene depth information and the second scene depth information; and
projecting the pixels of the edited first 2D image to the locations corresponding to the viewpoint of the second 2D image based on the relative 3D locations.

13. The electronic device of claim 10, wherein the editing the first 2D image and the editing of the second 2D image are performed using a neural network.

14. The electronic device of claim 13, wherein the neural network is a Denoising Diffusion Model.

15. The electronic device of claim 10, wherein the 3D image and the edited 3D image are Neural Radiance Fields (NeRFs).

16. The electronic device of claim 10, wherein a viewpoint of the first 2D image is adjacent to the viewpoint of the second 2D image.

17. The electronic device of claim 16, wherein the synthetic 2D image is a first synthetic 2D image, and the instructions further cause the at least one processor to:
generate a second synthetic 2D image from a viewpoint of a third 2D image of the plurality of 2D images, by projecting pixels of the edited second 2D image to locations corresponding to the viewpoint of the third 2D image;
edit the third 2D image based on the input and the second synthetic 2D image, to generate an edited third 2D image; and
generate the edited 3D image based on the edited first 2D image, the edited second 2D image, and the edited third 2D image.

18. The electronic device of claim 10, wherein the instructions further cause the at least one processor to:
edit the first 2D image based on the input multiple times, to generate a plurality of edited first 2D images; and
using a neural network, select one of the plurality of edited first 2D images as the edited first 2D image.

19. A non-transitory computer-readable storage medium, having a computer program stored thereon that performs, when executed by at least one processor:
acquiring a 3D image based on a plurality of two-dimensional (2D) images;
receiving an input for editing the 3D image;
editing a first 2D image among the plurality of 2D images based on the input, to generate an edited first 2D image;
generating a synthetic 2D image from a viewpoint of a second 2D image of the plurality of 2D images, by projecting pixels of the edited first 2D image to locations corresponding to the viewpoint of the second 2D image;
editing the second 2D image based on the input and the synthetic 2D image, to generate an edited second 2D image; and
generating an edited 3D image based on the edited first 2D image and the edited second 2D image.

20. The non-transitory computer-readable storage medium of claim 19,
wherein the input is a text-based input,
wherein the program further performs, when executed by the at least one processor, interpreting the text-based input using a neural network to generate an input interpretation, and
wherein the first 2D image and the second 2D image are edited based on the input interpretation.
